(19) United States
(12) Patent Application Publication
(10) Pub. No.: US 2026/0084735 A1
(43) Pub. Date: Mar. 26, 2026

(54) EXPANDABLE FOLDING CART

(71) Applicant: Wuyi Migo Leisure Products Co., Ltd., Jinhua (CN)

(72) Inventor: Peiwu WU, Wuhu (CN)

(73) Assignee: Wuyi Migo Leisure Products Co., Ltd., Jinhua (CN)

(21) Appl. No.: 18/978,141

(22) Filed: Dec. 12, 2024

(30) Foreign Application Priority Data
Sep. 26, 2024 (CN) 2024223573238

(51) Int. Cl. B62B 3/00; B62B 3/02

(52) U.S. Cl. CPC B62B 3/007; B62B 3/025; B62B 2205/06

(57) ABSTRACT

The present invention discloses an expandable folding cart, including a cart frame body and a wheel body assembly. The cart frame body includes a left shear fork group, a right shear fork group, a front side column group, a rear side column group, a stand column assembly, and a first underframe structure. An upper side of the first underframe structure and the stand column assembly surround to form a first mounting area for mounting a first cloth cover structure. A door frame structure is arranged at a side portion of the first mounting area. An object placing channel corresponding to the door frame structure is arranged on the first cloth cover structure. A lower portion of the door frame structure is rotatably connected to the stand column assembly, the first underframe structure or a lower portion of the rear side column group.

### CROSS-REFERENCE TO RELATED APPLICATIONS

The application claims priority to Chinese patent application No. 2024223573238, filed on Sep. 26, 2024, the entire contents of which are incorporated herein by reference.

### TECHNICAL FIELD

The present invention relates to the field of carts, and in particular, to an expandable folding cart.

### BACKGROUND

In the current cart market, a folding cart, as an important cargo handling apparatus, is more and more popular among contemporary people due to its simple structure and convenient storage in the trunk of a car or in the corner of a home.

The existing folding cart, such as a present invention patent with the publication number of CN217917997U entitled “a folding cart”, includes four support rods arranged in a square arrangement, a bottom bracket arranged between the four support bars, and side brackets arranged between adjacent support rods, and each side bracket is X-shaped and can be folded or unfolded synchronously along a length direction and width direction of a cart frame. However, after the folding cart in this technical solution is unfolded, objects can only be placed in a loading space surrounded by the side brackets and the bottom bracket, and the objects can only be put in or taken out from an upward side of the cart, so that the function is relatively simple, some longer objects are difficult to be laid horizontally in the loading space, and it is not convenient to stack and place longer objects smoothly. And the loading space is fixed in size, which is not suitable for some situations that need to expand the size of the loading space.

### SUMMARY

In view of deficiencies in the prior art, the present invention provides an expandable folding cart, objects can be put in or taken out from a loading space from the side of the cart frame body, which is convenient for stacking and placing some longer objects, and can expand the loading space at the side portion as required, with more diverse functions, higher use flexibility, and strong practicability.

The expandable folding cart provided by the present invention includes a cart frame body and a wheel body assembly for driving the cart frame body to move, where the cart frame body includes a left shear fork group, a right shear fork group, a front side column group respectively arranged between front ends of the left and right shear fork groups, a rear side column group respectively arranged between rear ends of the left and right shear fork groups, a stand column assembly for supporting the left and right shear fork groups and the front and rear side column groups, and a first underframe structure connected to a lower portion of the stand column assembly. An upper side of the first underframe structure and the stand column assembly surround to form a first mounting area for mounting a first cloth cover structure; a door frame structure is arranged at a side portion of the first mounting area; an object placing channel corresponding to the door frame structure is arranged on the first cloth cover structure; a door stopping member corresponding to the object placing channel is arranged on the door frame structure, where the door stopping member can move outward along with the door frame structure to open or close the object placing channel; a lower portion of the door frame structure is rotatably connected to the stand column assembly, the first underframe structure, or a lower portion of the rear side column group; a first connecting structure is connected between an upper portion of the door frame structure and the stand column assembly or the rear side column group; and the first connecting structure is arranged as a flexible belt, a flexible rope or a flexible chain, and is used for pulling the door frame structure to provide a supporting force for the door stopping member when the door stopping member opens the object placing channel.

Preferably, two opposite sides of the door frame structure are respectively provided with a first connecting structure, and when the door stopping member opens the object placing channel, an extended area for placing objects is formed between the two first connecting structures and an upper side of the door stopping member.

Preferably, a second connecting structure is also connected between the upper portion of the door frame structure and the stand column assembly or the rear side column group, the second connecting structure includes a first buckling member arranged on the upper portion of the door frame structure and a second buckling member arranged on the stand column assembly or the rear side column group, and when the door stopping member closes the object placing channel, the first buckling member and the second buckling member are fastened with each other for positioning and holding.

Preferably, the first buckling member includes a first buckling body, a first clamping portion connected to the first buckling body, and a first buckling portion connected to an outer end of the first clamping portion, where the first buckling portion is provided with two buckling plates respectively protruding from both sides of the first clamping portion, a buckling connecting plate connected between ends of the two buckling plates, and a movable plate respectively arranged between the two buckling plates at intervals, where one end of the movable plate is connected to the buckling connecting plate, the other end is provided with a buckling point protruding outwards, and the first clamping portion is internally provided with a movable groove for the movable plate to deflect inwards; and the second buckling member includes a second buckling body, second clamping portions connected to the second buckling body and arranged oppositely, a second buckling portion respectively extending in a direction from one second clamping portion towards an opposite second clamping portion, and a buckling limiting plate connected between ends of the two second clamping portions, where the second buckling body, the second clamping portions, and the second buckling portion surround to form a buckling groove for slidably connecting to a first buckling plate; the second buckling body is concavely provided with a point groove corresponding to the buckling point; when the first buckling member and the second buckling member are fastened and connected, the buckling point is concavely and convexly matched with the point groove; and the buckling limiting plate abuts against an end face of the first buckling portion far from the buckling point.

Preferably, the stand column assembly includes a plurality of first support stand columns respectively connected to end portions of two adjacent shear fork groups or side column groups, two opposite sides of the door frame structure are respectively provided with a second connecting structure, the second buckling member of the two second connecting structures are respectively connected to a first support stand column correspondingly arranged at a rear side through a flexible member in a positioning manner, the second buckling portion is arranged on one side of a second buckling plate close to the object placing channel, one side of the second buckling body far away from the object placing channel and/or an outer side of the second clamping portion is convexly provided with a penetration plate arranged along a length direction of the second clamping portion, a penetration channel for the flexible member to pass through is arranged on the penetration plate, one end of the flexible member is sleeved on the penetration plate and the other end is sleeved on the first support stand columns, and the flexible member is arranged as the flexible belt, the flexible rope, or the flexible chain.

Preferably, the door frame structure includes two door frame stand columns oppositely arranged along a longitudinal direction and a door stopping bracket connected between the two door frame stand columns, an upper end of the door frame stand column is provided with a first door frame connecting structure, and a lower end of the door frame stand column is provided with a second door frame connecting structure; the first door frame connecting structure includes a first base fixed relative to an upper end of the door frame stand column, a first assembling portion extending in a direction from the first base towards an opposite door frame stand column, and a second assembling portion extending from the first base or the first assembling portion towards a direction close to the object placing channel, upper sides of two ends of the door stopping bracket are respectively rotatably connected to the first assembly portion of the two first door frame connecting structures, an upper end of the door stopping member is provided with a door stopping mounting buckle in buckled connection with the second assembling portion, the first buckling member is arranged on one side of the first base far away from the object placing channel, and one end of the first connecting structure is connected to one side of the first base far away from the door stopping bracket in a positioning manner; and the second door frame connecting structure includes a second base fixed relative to a lower end of the door frame stand column, a third assembling portion extending in a direction from the second base towards an opposite door frame stand column, and a fourth assembling portion extending from the second base towards a direction far away from the first door frame connecting structure, lower sides of two ends of the door stopping bracket are respectively rotatably connected to the third assembly portion of the two second door frame connecting structures, and the fourth assembling portion is rotatably connected to a lower portion of the first support stand column.

Preferably, the front side column group, the rear side column group, and the door stopping bracket are arranged as a shear fork structure, and the stand column assembly further includes a first assembly structure arranged at a lower portion of the first support stand column and a second assembly structure arranged first support stand column and above the first assembly structure; the first assembly structure on each of the two first support stand columns at the rear side includes a first connecting base fixed relative to a lower portion of each first support stand column, a first assembly portion extending in a direction from the first connecting base towards the first underframe structure, and a second assembly portion extending in a direction from the first connecting base towards the door frame structure, both sides of a rear end of the first underframe structure are respectively rotatably connected to first assembly portions of the two first assembly structures, and the two fourth assembly portions are respectively rotatably connected to the second assembly portions of the two first assembly structures; and the second assembly structure on each of the two first support stand columns at the rear side includes a second connecting base connected to each first support stand column, a third assembly portion extending in a direction from the second connecting base towards the rear side column group, and a fourth assembly portion extending in a direction from the second connecting base towards the left shear fork group or the right shear fork group, both sides of the rear side column group are respectively rotatably connected to the third assembly portions of the two second assembly structures, both rear ends of the left and right shear fork groups are respectively rotatably connected to the fourth assembly portion of a second assembly structure correspondingly arranged, and the other end of the first connecting structure is connected with an outer side of the second assembly structure in a positioning manner.

Preferably, the stand column assembly further includes a second support stand column rotatably connected to the left shear fork group and a third support stand column rotatably connected to the right shear fork group; the first underframe structure includes first underframe assemblies respectively arranged between the two first support stand columns at a front side and the lower portions of the second and third support stand columns and arranged between the two first support stand columns at a rear side and the lower portions of the second and third support stand columns; the second underframe structure includes second underframe assemblies respectively arranged between the two first support stand columns at a front side and the lower portions of the second and third support stand columns and arranged between the two first support stand columns at a rear side and the lower portions of the second and third support stand columns; the first and second underframe assemblies are respectively provided with a first bottom rod rotatably connected to the two first support stand columns, a second bottom rod rotatably connected to the second support stand column, a third bottom rod rotatably connected to the third support stand column, and a folding connecting member; and when the cart frame body is driven to fold, the front, rear, left and right shear fork groups deform to drive the first, second and third support stand columns to be gathered with each other, and the first, second and third bottom rods are gathered with each other to drive the folding connecting member to move upwards.

Preferably, the cart frame body also includes a second underframe structure arranged above the first underframe structure, an upper side of the second underframe structure and the stand column assembly surround to form a second mounting area for mounting a second cloth cover structure, and the second mounting area is arranged above the first mounting area; the stand column assembly includes a plurality of first support stand columns respectively connected to end portions of two adjacent shear fork groups or side column groups, first assembly structures arranged at lower portions of the first support stand columns, second assembly structures arranged at middle portions of the first support stand columns, and third assembly structures arranged at upper portions of the first support stand columns; the second assembly structure on each of the two first support stand columns at the rear side includes a second connecting base slidably sleeved to a middle portion of each first support stand column, a third assembly portion extending in a direction from the second connecting base towards the rear side column group, a fourth assembly portion extending in a direction from the second connecting base towards the left shear fork group or the right shear fork group, and a fifth assembly portion extending in a direction from the second connecting base towards the second underframe structure; lower ends of both sides of the rear side column group are respectively rotatably connected to the third assembly portions of the two second assembly structures; lower sides of both rear ends of the left and right shear fork groups are respectively rotatably connected to the fourth assembly portion of a second assembly structure correspondingly arranged, and both sides of the rear end of the second underframe structure are respectively connected to the fifth assembly portions of the two second assembly structures; the third assembly structure on each of the two first support stand columns at the rear side includes a third connecting base fixed relative to an upper portion of each first support stand column, a sixth assembly portion extending in a direction from the third connecting base towards the rear side column group, a seventh assembly portion extending in a direction from the third connecting base towards the left shear fork group or the right shear fork group; upper ends of both sides of the rear side column group are respectively rotatably connected to the sixth assembly portions of the two third assembly structures; and an upper side of one end of the left shear fork group and an upper side of one end of the right shear fork group are respectively rotatably connected to the seventh assembly portion of a third assembly structure correspondingly arranged; and the first cloth cover structure is provided with a first mounting buckle arranged corresponding to each second assembly structure, a side portion of the third assembly portion or the fourth assembly portion or the fifth assembly portion is provided with a first quick-release portion detachably connected to the first mounting buckle, the second cloth cover structure is provided with a second mounting buckle arranged corresponding to each third cart frame connecting structure, and an inner side of the third connecting base is provided with a second quick-release portion detachably connected to the second mounting buckle.

Preferably, the cart frame body also includes a second underframe structure arranged above the first underframe structure, an upper side of the second underframe structure and the stand column assembly surround to form a second mounting area for mounting a second cloth cover structure, and the second mounting area is arranged above the first mounting area; the stand column assembly includes a plurality of first support stand columns respectively connected to end portions of two adjacent shear fork groups or side column groups, the front side column group includes a first front side column beam which is relatively fixedly connected between lower portions of the two first support stand columns at the front end and a second front side column beam which is relatively fixedly connected between middle portions of the two first support stand columns at the front end, the rear side column group includes a first rear side column beam which is relatively fixedly connected between lower portions of the two first support stand columns at the rear end and a second rear side column beam which is relatively fixedly connected between middle portions of the two first support stand columns at the rear end, the first underframe structure includes first underframe assemblies which are rotatably connected to each other and are rotatably connected to the first front side column beam and the first rear side column beam respectively, the second underframe structure includes second underframe assemblies which are rotatably connected to each other and are rotatably connected to the second front side column beam and the second rear side column beam respectively, the door frame structure includes two door frame stand columns which are oppositely arranged along a longitudinal direction and a door stopping bracket which is connected between the two door frame stand columns, and the front side column group, the rear side column group, the door stopping bracket, the first underframe assemblies and the second underframe assemblies are arranged in a plate-frame structure; and a lower portion of the door frame structure is rotatably connected to the first rear side column beam, one end of the first connecting structure is connected to upper portions of the door frame stand column in a positioning manner and the other end is connected to the second rear side column beam in a positioning manner, the door stopping bracket includes bracket beams connected between upper ends of the two door frame stand columns, the first buckling member of the second connecting structure is formed by the bracket beams, and the second buckling member is connected to the second rear side column beam in a positioning manner.

According to the expandable folding cart provided in the present invention, at least one side of the first mounting area is provided with a door frame structure, an object placing channel corresponding to the door frame structure is arranged on the first cloth cover structure, and a door stopping member corresponding to the object placing channel is arranged on the door frame structure. A lower portion of the door frame structure is rotatably connected to the stand column assembly, the first underframe structure or a lower portion of the rear side column group, by operating the door frame structure to rotate downwards, the door stopping member can be driven to open the object placing channel, and objects can be placed in or taken out from a loading space formed in the first cloth cover structure through the side of the cart frame body, so that some longer objects can be stacked and placed smoothly, or objects at the bottom can be taken out directly from the object placing channel at the side when the objects are stacked. A first connecting structure is connected between an upper portion of the door frame structure and the stand column assembly or the rear side column group, is used for pulling the door frame structure to provide a supporting force for the door stopping member when the door stopping member opens the object placing channel, so that the door frame structure forms an expanded loading space at the side of the cart frame body, objects can be selectively placed in the expanded loading space, with more diverse functions, higher use flexibility, and strong practicability. The first connecting structure is arranged as a flexible belt, a flexible rope or a flexible chain, so that the first connecting structure forms a triangular supporting structure with the door frame structure and the stand column assembly or the rear side column group after the door frame structure is unfolded. The door frame structure can bear a certain weight under the pull of the first connecting structure, and it is more stable when carrying objects, so that the first connecting structure can bend and deform at will during the unfolding or folding of the door frame structure. The design of the flexible belt, the flexible rope or the flexible chain is simple in structure, which reduces complexity of use and increases user experience.

Additional aspects and advantages of the present invention will be partially presented in the following description, some of which will become apparent from the following description, or learned through practice of the present invention.

### BRIEF DESCRIPTION OF THE DRAWINGS

The accompanying drawings illustrated herein are used to provide a further understanding of the present invention, and form part of the specification, and are used together with embodiments of the present invention to explain the present invention, and do not constitute a limitation on the present invention. In the drawings:

FIG. 1 is a schematic diagram 1 of a structure of a folding cart according to an embodiment of the present invention;

FIG. 2 is a schematic diagram 1 of a part of a structure of a folding cart according to an embodiment of the present invention;

FIG. 3 is a schematic diagram of a structure of a first buckling member according to an embodiment of the present invention;

FIG. 4 is a schematic diagram of a structure of a second buckling member according to an embodiment of the present invention;

FIG. 5 is a schematic diagram of a structure of a stand column assembly and a first connecting structure according to an embodiment of the present invention;

FIG. 6 is a schematic diagram of a structure of a door frame structure according to an embodiment of the present invention;

FIG. 7 is a schematic diagram of a structure of a first base according to an embodiment of the present invention;

FIG. 8 is a schematic diagram 2 of a part of a structure of a folding cart according to an embodiment of the present invention;

FIG. 9 is a schematic diagram of a structure of a first assembly structure according to an embodiment of the present invention;

FIG. 10 is a schematic diagram 3 of a part of a structure of a folding cart according to an embodiment of the present invention;

FIG. 11 is a schematic diagram 2 of a structure of a folding cart according to an embodiment of the present invention;

FIG. 12 is a diagram of a folding state of a folding cart according to an embodiment of the present invention; and

FIG. 13 is a schematic diagram of a part of a structure of a folding cart according to another embodiment of the present invention.

### DETAILED DESCRIPTION OF THE EMBODIMENTS

To make the objectives, technical solutions, and advantages of the present invention clearer, the following clearly and completely describes the technical solutions of the present invention with reference to the accompanying drawings of embodiments of the present invention. Apparently, the embodiments described are merely a part rather than all of the embodiments of the present invention. All other embodiments obtained by those of ordinary skill in the art based on the described embodiments of the present invention without creative efforts shall fall within the protection scope of the present invention.

In the description of the present invention, it should be understood that the orientations or positional relationships indicated by the terms “upper”, “lower”, “front”, “rear”, “left”, “right”, “top”, “bottom”, “inner”, “outer”, and the like are in accordance with those shown in the accompanying drawings, and are intended only for the convenience of describing the present invention and simplifying the description rather than for indicating or implying that the referred devices or elements must be provided with a particular orientation or constructed or operated in a particular orientation; and therefore, these terms should not be construed as a limitation on the present invention.

In the present invention, unless otherwise explicitly provided and limited, the terms “mounted”, “connected”, and “connection”, and “fixed” should be understood in a broad sense, for example, it may be a fixed connection, a detachable connection, or an integral connection; it may be a mechanical connection or an electrical connection; it may be a direct connection or an indirect connection through an intermediate medium; and it may be a connection between two elements. For those of ordinary skill in the art, the specific meaning of the above-mentioned terms in the present invention can be construed according to specific cases.

In the present invention, unless otherwise expressly specified and defined, a first feature being “above” or “below” a second feature may include not only direct contact between the first and second features but also indirect contact between the first and second features via another feature between them. Furthermore, a first feature being “above” a second feature includes the first feature being directly above and diagonally above the second feature, or simply means that the first feature is higher in level than the second feature. Furthermore, a first feature being “below” a second feature includes the first feature being directly below and diagonally below the second feature, or simply means that the first feature is lower in level than the second feature.

Unless otherwise defined, the technical or scientific terms used in the present invention shall have the common meanings as understood by those skilled in the art to which the present invention belongs. The terms “first”, “second”, and the like used in the specification and the claims of the present invention are not intended to indicate any sequence, amount or importance, but distinguish different components. Also, the terms such as “a”, “an”, and the like are not intended to limit the amount, but indicate the existence of at least one.

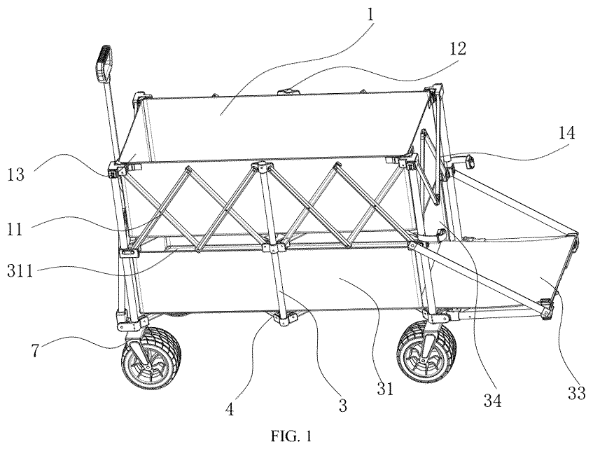

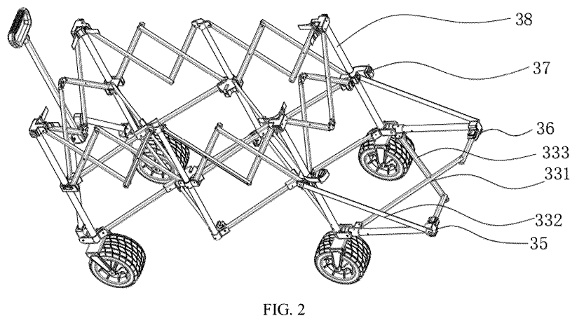

As shown in FIG. 1 and FIG. 2, as an embodiment of the present invention, an expandable folding cart is provided, including a cart frame body 1, a first underframe structure 4 connected to a lower portion of a stand column assembly 3, and a wheel body assembly 7 for driving the cart frame body 1 to move. The cart frame body 1 includes a left shear fork group 11, a right shear fork group 12, a front side column group 13 respectively arranged between front ends of the left and right shear fork groups, a rear side column group 14 respectively arranged between rear ends of the left and right shear fork groups, a stand column assembly 3 for supporting the left and right shear fork groups and the front and rear side column groups, and a first underframe structure 4 connected to a lower portion of the stand column assembly 3. An upper side of the first underframe structure 4 and the stand column assembly surround to form a first mounting area 311 for mounting a first cloth cover structure 31. According to the expandable folding cart in this embodiment, at least one side of the first mounting area 311 is provided with a door frame structure 33, an object placing channel 34 corresponding to the door frame structure 33 is arranged on the first cloth cover structure 31, and a door stopping member 331 corresponding to the object placing channel 34 is arranged on the door frame structure 33. A lower portion of the door frame structure 33 is rotatably connected to the stand column assembly 3, the first underframe structure 4 or a lower portion of the rear side column group 14, by operating the door frame structure 33 to rotate downwards, the door stopping member 331 can be driven to open the object placing channel 34, and objects can be placed in or taken out from a loading space formed in the first cloth cover structure 31 through the side of the cart frame body 1, so that some longer objects can be stacked and placed smoothly, or objects at the bottom can be taken out directly from the object placing channel 34 at the side when the objects are stacked. A first connecting structure 332 is connected between an upper portion of the door frame structure 33 and the stand column assembly 3 or the rear side column group 14, is used for pulling the door frame structure 33 to provide a supporting force for the door stopping member 331 when the door stopping member 331 opens the object placing channel 34, so that the door frame structure 33 forms an expanded loading space at the side of the cart frame body, objects can be selectively placed in the expanded loading space, with more diverse functions, higher use flexibility, and strong practicability. The first connecting structure 332 is arranged as a flexible belt, a flexible rope or a flexible chain, so that the first connecting structure 332 forms a triangular supporting structure with the door frame structure 33 and stand column assembly 3 or the rear side column group 14 after the door frame structure 33 is unfolded. The door frame structure 33 can bear a certain weight under the pull of the first connecting structure 332, and it is more stable when carrying objects, so that the first connecting structure 332 can bend and deform at will during the unfolding or folding of the door frame structure 33. The design of the flexible belt, the flexible rope or the flexible chain is simple in structure, which reduces complexity of use and increases user experience. In this embodiment, the left and right shear fork groups are respectively arranged on both sides of the cart frame body 1 in a width direction, and the front and rear side column groups are respectively arranged on both sides of the cart frame body 1 in a length direction, so that the door frame structure 33 is arranged on one side of the cart frame body 1 in the length direction, which can extend a length of the loading space in the first cloth cover structure 31 when unfolded, and is suitable for placing some longer objects. As another embodiment of the present invention, the left and right shear fork groups are respectively arranged on both sides of the cart frame body 1 in a length direction, and the front and rear side column groups are respectively arranged on both sides of the cart frame body 1 in a width direction, so that the door frame structure 33 is arranged on one side of the cart frame body in the width direction, which can extend a width of the loading space in the first cloth cover structure when unfolded, and is suitable for placing some wider objects.

In another embodiment, as shown in FIG. 2, two opposite sides of the door frame structure 33 are respectively provided with a first connecting structure 332, and when the door stopping member 331 opens the object placing channel 34, an extended area 333 for placing objects is formed between the two first connecting structures 332 and an upper side of the door stopping member 331, which can increase the loading space of the entire cart and place more objects. Also, the objects placed in the extended area 333 can be limited by the two first connecting structures 332 to prevent the objects from slipping from both sides of the extended area 333.

As shown in FIG. 2, a second connecting structure 35 is also connected between the upper portion of the door frame structure 33 and the stand column assembly 3 or the rear side column group 14, the second connecting structure 35 includes a first buckling member 36 arranged on the upper portion of the door frame structure 33 and a second buckling member 37 arranged on the stand column assembly 3 or the rear side column group 14, and when the door stopping member 331 closes the object placing channel 34, the first buckling member 36 and the second buckling member 37 are fastened with each other for positioning and holding, thus reducing a gap between the door stopping member 331 and the stand column assembly, and making space occupation of the entire cart after being folded smaller.

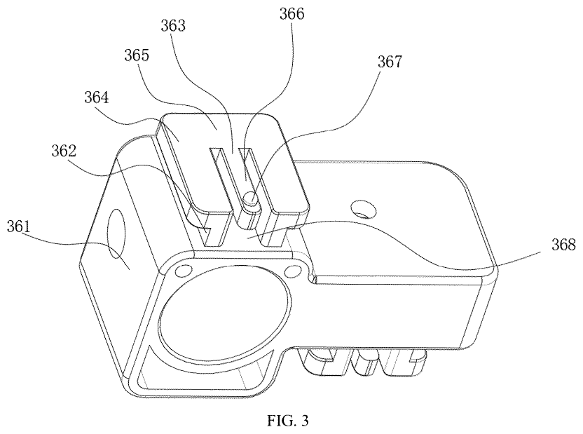

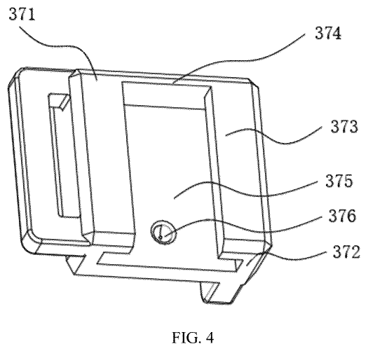

As shown in FIG. 3 and FIG. 4, the first buckling member 36 includes a first buckling body 361, a first clamping portion 362 connected to the first buckling body 361, and a first buckling portion 363 connected to an outer end of the first clamping portion 362, where the first buckling portion 363 is provided with two buckling plates 364 respectively protruding from both sides of the first clamping portion 362, a buckling connecting plate 365 connected between ends of the two buckling plates 364, and a movable plate 366 respectively arranged between the two buckling plates 364 at intervals; one end of the movable plate 366 is connected to the buckling connecting plate 365, and the other end is provided with a buckling point 367 protruding outwards; and the first clamping portion 362 is internally provided with a movable groove 368 for the movable plate 366 to deflect inwards. Protrusion of the buckling point 367 and the buckling plates 364 makes the two buckling members cooperate more closely when being fastened. The second buckling member 37 includes a second buckling body 371, second clamping portions 372 connected to the second buckling body 371 and arranged oppositely, a second buckling portion 373 respectively extending from each second clamping portion 372 towards an opposite second clamping portion 372, and a buckling limiting plate 374 connected between ends of the two second clamping portions 372. The second buckling body 371, the second clamping portions 372, and the second buckling portion 373 surround to form a buckling groove 375 for slidably connecting to a first buckling plate 369; the second buckling body 371 is concavely provided with a point groove 376 corresponding to the buckling point 367; when the first buckling member 36 and the second buckling member 37 are fastened and connected, the buckling point 367 is concavely and convexly matched with the point groove 376; and the buckling limiting plate 374 abuts against an end face of the first buckling portion 363 far from the buckling point, which increases the buckling compatibility, and reduces the gap between the door stopping member 331 and the stand column in a folded state.

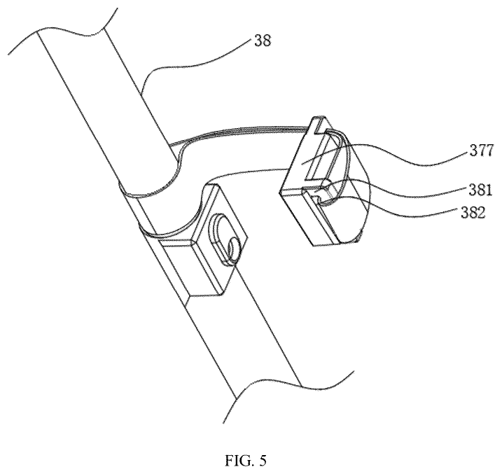

As shown in FIG. 5, the stand column assembly 3 includes a plurality of first support stand columns 38 respectively connected to end portions of two adjacent shear fork groups or side column groups, two opposite sides of the door frame structure 33 are respectively provided with a second connecting structure 35, the second buckling member 37 of the two second connecting structures 35 are respectively connected to a first support stand column 38 correspondingly arranged at a rear side through a flexible member in a positioning manner, the second buckling portion 373 is arranged on one side of a second buckling plate 377 close to the object placing channel 34, one side of the second buckling body 371 far away from the object placing channel 34 and/or an outer side of the second clamping portion 372 is convexly provided with a penetration plate 381 arranged along a length direction of the second clamping portion 372, a penetration channel 382 for the flexible member to pass through is arranged on the penetration plate 381, one end of the flexible member is sleeved on the penetration plate 381 and the other end is sleeved on the first support stand columns 38, and the flexible member is arranged as the flexible belt, the flexible rope, or the flexible chain, which is convenient for adjusting a height of the second buckling member 37 and reduces the matching difficulty of the second buckling member 37 and the first buckling member 36.

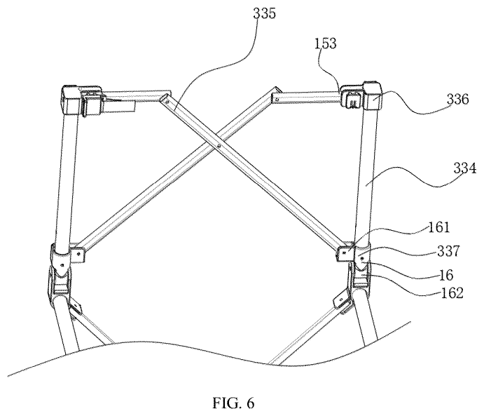

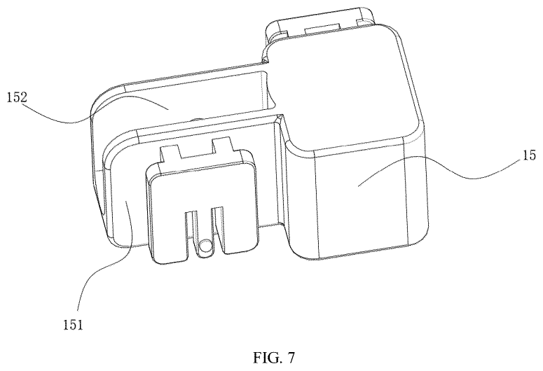

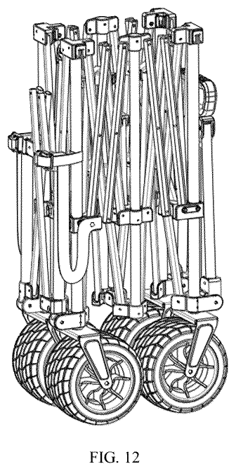

As shown in FIG. 6, FIG. 7, and FIG. 12, the door frame structure 33 includes two door frame stand columns 334 oppositely arranged along a longitudinal direction and a door stopping bracket 335 connected between the two door frame stand columns 334, an upper end of the door frame stand column 334 is provided with a first door frame connecting structure 336, and a lower end of the door frame stand column is provided with a second door frame connecting structure 337. The first door frame connecting structure 336 includes a first base 15 fixed relative to an upper end of the door frame stand column 334, a first assembling portion 151 extending in a direction from the first base 15 towards an opposite door frame stand column 334, and a second assembling portion 152 extending in a direction from the first base 15 or the first assembling portion 151 towards a direction close to the object placing channel 34, upper sides of two ends of the door stopping bracket 335 are respectively rotatably connected to the first assembly portion 151 of the two first door frame connecting structures 336, so that when the entire cart is folded, the door stopping bracket can be deformed along with deformation of the underframe structure, thus reducing the folded volume, an upper end of the door stopping member 331 is provided with a door stopping mounting buckle 153 in buckled connection with the second assembling portion 152, the first buckling member 36 is arranged on one side of the first base 15 far away from the object placing channel 34, and one end of the first connecting structure 332 is connected to one side of the first base 15 far away from the door stopping bracket 335 in a positioning manner. The second door frame connecting structure 337 includes a second base 16 fixed relative to a lower end of the door frame stand column 334, a third assembling portion 161 extending from the second base 16 towards a direction of an opposite door frame stand column 334, and a fourth assembling portion 162 extending from the second base 16 towards a direction far away from the first door frame connecting structure 336, lower sides of two ends of the door stopping bracket 335 are respectively rotatably connected to the third assembly portion 161 of the two second door frame connecting structures 337, and the fourth assembling portion 162 is rotatably connected to a lower portion of the first support stand column 38, so that when the entire cart is folded, the door stopping bracket can be deformed along with deformation of the underframe structure, thus reducing the folded volume.

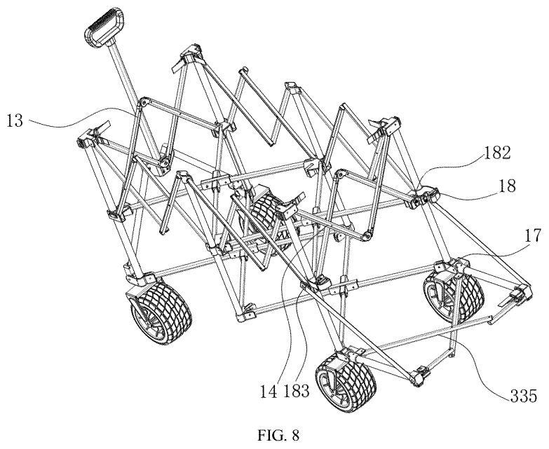

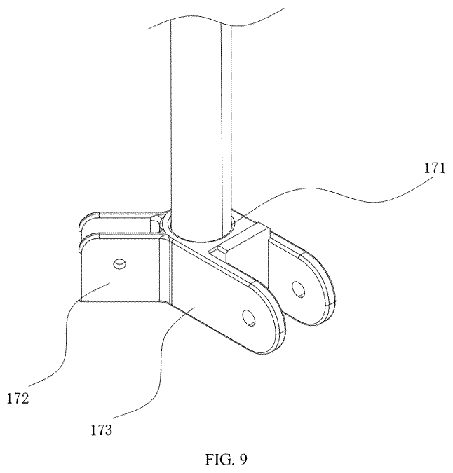

As shown in FIG. 8 and FIG. 9, the front side column group 13, the rear side column group 14, and the door stopping bracket 335 are arranged as a shear fork structure, and the stand column assembly 3 further includes a first assembly structure 17 arranged at a lower portion of the first support stand column 38 and a second assembly structure 18 arranged on the first support stand column 38 and above the first assembly structure 17. The first assembly structure 17 on the two first support stand columns 38 at the rear side includes a first connecting base 171 fixed relative to a lower portion of the first support stand column 38, a first assembly portion 172 extending in a direction from the first connecting base 171 towards the first underframe structure 4, and a second assembly portion 173 extending in a direction from the first connecting base 171 towards the door frame structure 33, both sides of a rear end of the first underframe structure 4 are respectively rotatably connected to the first assembly portions 172 of the two first assembly structures 17, and the two fourth assembly portions 162 are respectively rotatably connected to the second assembly portions 173 of the two first assembly structures 17, which facilitates the unfolding and folding of the door frame structure 33. The second assembly structure 18 on the two first support stand columns 38 at the rear side includes a second connecting base 181 connected to the first support stand column 38, a third assembly portion 182 extending in a direction from the second connecting base 181 towards the rear side column group 14, and a fourth assembly portion 183 extending in a direction from the second connecting base 181 towards the left shear fork group 11 or the right shear fork group 12, both sides of the rear side column group 14 are respectively rotatably connected to the third assembly portions 182 of the two second assembly structures 173, both rear ends of the left and right shear fork groups are respectively rotatably connected to the fourth assembly portions 183 of the second assembly structure 18 correspondingly arranged, and the other end of the first connecting structure 332 is connected with an outer side of the second assembly structure 18 in a positioning manner, so that the entire cart can be folded and unfolded more smoothly and easily.

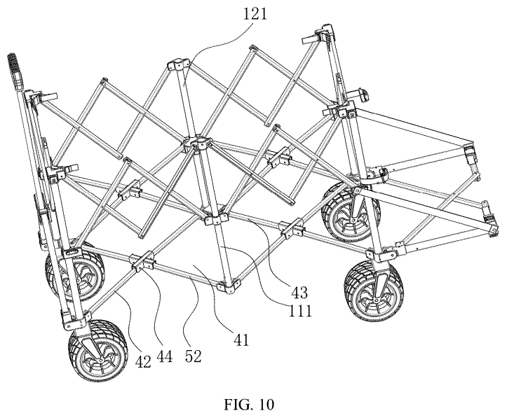

As shown in FIG. 10, the stand column assembly 3 further includes a second support stand column 111 rotatably connected to the left shear fork group 11 and a third support stand column 121 rotatably connected to the right shear fork group 12; the first underframe structure 4 includes first underframe assemblies 41 respectively arranged between the two first support stand columns 38 at a front side and the lower portions of the second and third support stand columns and arranged between the two first support stand columns 38 at a rear side and the lower portions of the second and third support stand columns; the second underframe structure 5 includes second underframe assemblies 51 respectively arranged between the two first support stand columns 38 at a front side and the lower portions of the second and third support stand columns and arranged between the two first support stand columns 38 at a rear side and the lower portions of the second and third support stand columns; and the first and second underframe assemblies are respectively provided with a first bottom rod 42 rotatably connected to the two first support stand columns 38, a second bottom rod 52 rotatably connected to the second support stand column 111, a third bottom rod 43 rotatably connected to the third support stand column 121, and a folding connecting member 44. When the cart frame body 1 is driven to fold, the front, rear, left and right shear fork groups deform to drive each first support stand column 38, the second support stand column 111, and the third support stand column 121 to be gathered with each other, and the first bottom rod 42, the second bottom rod 52, and the third bottom rod 43 are gathered with each other to drive the folding connecting member 44 to move upwards. Double underframe structures make it possible to classify objects better when the objects are placed, the first underframe structure places heavy and bulky goods, and the second underframe structure places lighter and commonly used goods, which increases the diversity of the cart, improves practicality, and is convenient for use.

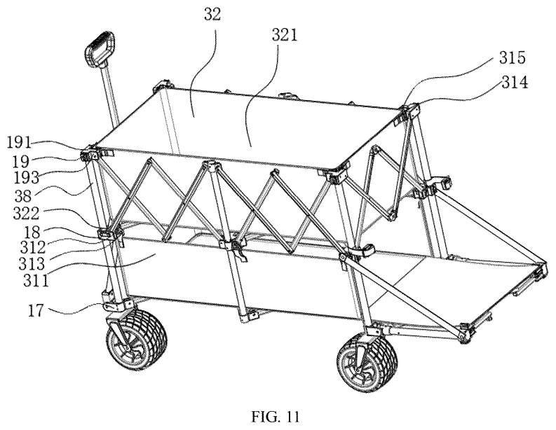

As shown in FIG. 11, the cart frame body also includes the second underframe structure 5 arranged above the first underframe structure 4, an upper side of the second underframe structure 5 and the stand column assembly 3 surround to form a second mounting area 321 for mounting a second cloth cover structure 32, the second mounting area 321 is arranged above the first mounting area 311, and the stand column assembly 3 includes a plurality of first support stand columns 38 respectively connected to end portions of two adjacent shear fork groups or side column groups, first assembly structures 17 arranged at lower portions of the first support stand columns 38, second assembly structures 18 arranged at middle portions of the first support stand columns 38, and third assembly structures 19 arranged at upper portions of the first support stand columns 38.

The second assembly structure 18 on each of the two first support stand columns 38 at the rear side includes a second connecting base 181 slidably sleeved to a middle portion of each first support stand column 38, a third assembly portion 182 extending in a direction from the second connecting base 181 towards the rear side column group, a fourth assembly portion 183 extending in a direction from the second connecting base 181 towards the left shear fork group 11 or the right shear fork group 12, and a fifth assembly portion 322 extending in a direction from the second connecting base 181 towards the second underframe structure 32. Lower ends of both sides of the rear side column group 14 are respectively rotatably connected to the third assembly portions 182 of the two second assembly structures 18; lower sides of both rear ends of the left and right shear fork groups are respectively rotatably connected to the fourth assembly portion 183 of a second assembly structure 18 correspondingly arranged, and both sides of the rear end of the second underframe structure 51 are respectively connected to the fifth assembly portions 322 of the two second assembly structures 18; the third assembly structure 19 on each of the two first support stand columns 38 at the rear side includes a third connecting base 191 fixed relative to an upper portion of each first support stand column 38, a sixth assembly portion 192 extending in a direction from the third connecting base 191 towards the rear side column group, a seventh assembly portion 193 extending in a direction from the third connecting base 191 towards the left shear fork group 11 or the right shear fork group 12; upper ends of both sides of the rear side column group 14 are respectively rotatably connected to the sixth assembly portions 192 of the two third assembly structures 19; and an upper side of one end of the left shear fork group and an upper side of one end of the right shear fork group are respectively rotatably connected to the seventh assembly portion 193 of a third assembly structure 19 correspondingly arranged, so that when the entire cart is folded, the first and second underframe structures are folded synchronously, thus reducing the volume after the cart is folded.

The first cloth cover structure 31 is provided with a first mounting buckle 312 arranged corresponding to each second assembly structure 18, a side portion of the third assembly portion 182 or the fourth assembly portion 193 or the fifth assembly portion 322 is provided with a first quick-release portion 313 detachably connected to the first mounting buckle 312, the second cloth cover structure 32 is provided with a second mounting buckle 314 arranged corresponding to each third cart frame connecting structure, and an inner side of the third connecting base 191 is provided with a second quick-release portion 315 detachably connected to the second mounting buckle 314, so that it is convenient to assemble and disassemble the cloth cover, making the cleaning easier, and not easy to damage the cart body because the cloth cover is not easy to assemble and disassemble.

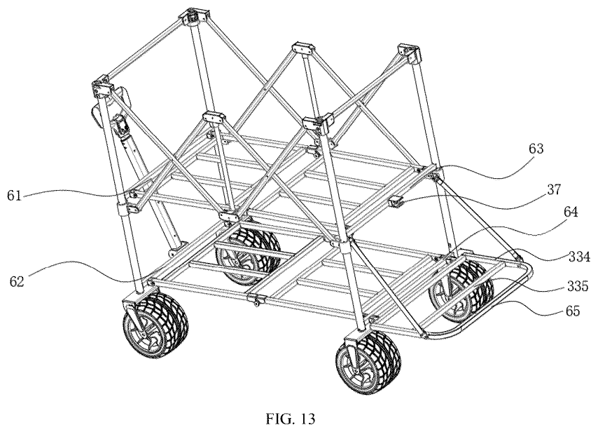

As shown in FIG. 13, in another embodiment provided in the present invention, another expandable folding cart is provided. A difference between this embodiment and the former embodiment lies in that, this embodiment includes a second underframe structure 5 arranged above the first underframe structure 4, an upper side of the second underframe structure 5 and the stand column assembly 3 surround to form a second mounting area 321 for mounting a second cloth cover structure 32, and the second mounting area 321 is arranged above the first mounting area 311.

The stand column assembly 3 includes a plurality of first support stand columns 38 respectively connected to end portions of two adjacent shear fork groups or side column groups, the front side column group 13 includes a first front side column beam 61 which is relatively fixedly connected between lower portions of the two first support stand columns 38 at the front end and a second front side column beam 62 which is relatively fixedly connected between middle portions of the two first support stand columns 38 at the front end, and the rear side column group includes a first rear side column beam 63 which is relatively fixedly connected between lower portions of the two first support stand columns at the rear end and a second rear side column beam 64 which is relatively fixedly connected between middle portions of the two first support stand columns 38 at the rear end. The first underframe structure 4 includes first underframe assemblies 41 which are rotatably connected to each other and are rotatably connected to the first front side column beam and the first rear side column beam respectively, the second underframe structure 5 includes second underframe assemblies 51 which are rotatably connected to each other and are rotatably connected to the second front side column beam and the second rear side column beam respectively, and the door frame structure 33 includes two door frame stand columns 334 which are oppositely arranged along a longitudinal direction and a door stopping bracket 335 which is connected between the two door frame stand columns 334. The front side column group 13, the rear side column group 14, the door stopping bracket 335, the first underframe assemblies 41 and the second underframe assemblies 51 are arranged in a plate-frame structure, so that when carrying heavy objects to the underframe assemblies, the bearing capacity is stronger, and stacking and folding are easier.

A lower portion of the door frame structure 33 is rotatably connected to the first rear side column beam 63, one end of the first connecting structure 332 is connected to upper portions of the door frame stand column 334 in a positioning manner and the other end is connected to the second rear side column beam 64 in a positioning manner, the door stopping bracket 335 includes bracket beams 65 connected between upper ends of the two door frame stand columns 334, the first buckling member 37 of the second connecting structure 35 is formed by the bracket beams 65, and the second buckling member 37 is connected to the second rear side column beam 64 in a positioning manner, so that it is easier to buckle and open, and is convenient to operate.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

In conclusion, the foregoing descriptions are merely a preferred embodiment of the present invention. Any equivalent changes and modifications made within the patent scope of the present invention should fall within the scope of the present invention patent.

What is claimed is:

1. An expandable folding cart, comprising a cart frame body and a wheel body assembly for driving the cart frame body to move, wherein
the cart frame body comprises a left shear fork group, a right shear fork group, a front side column group respectively arranged between front ends of the left and right shear fork groups, a rear side column group respectively arranged between rear ends of the left and right shear fork groups, a stand column assembly for supporting the left and right shear fork groups and the front and rear side column groups, and a first underframe structure connected to a lower portion of the stand column assembly; and
an upper side of the first underframe structure and the stand column assembly surround to form a first mounting area for mounting a first cloth cover structure; a door frame structure is arranged at a side portion of the first mounting area; an object placing channel corresponding to the door frame structure is arranged on the first cloth cover structure; a door stopping member corresponding to the object placing channel is arranged on the door frame structure, where the door stopping member can move outward along with the door frame structure to open or close the object placing channel; a lower portion of the door frame structure is rotatably connected to the stand column assembly, the first underframe structure, or a lower portion of the rear side column group; a first connecting structure is connected between an upper portion of the door frame structure and the stand column assembly or the rear side column group; and the first connecting structure is arranged as a flexible belt, a flexible rope or a flexible chain, and is used for pulling the door frame structure to provide a supporting force for the door stopping member when the door stopping member opens the object placing channel.

2. The folding cart according to claim 1, wherein two opposite sides of the door frame structure are respectively provided with a first connecting structure, and when the door stopping member opens the object placing channel, an extended area for placing objects is formed between the two first connecting structures and an upper side of the door stopping member.

3. The folding cart according to claim 2, wherein a second connecting structure is also connected between the upper portion of the door frame structure and the stand column assembly or the rear side column group, the second connecting structure comprises a first buckling member arranged on the upper portion of the door frame structure and a second buckling member arranged on the stand column assembly or the rear side column group, and when the door stopping member closes the object placing channel, the first buckling member and the second buckling member are fastened with each other for positioning and holding.

4. The folding cart according to claim 3, wherein the first buckling member comprises a first buckling body, a first clamping portion connected to the first buckling body, and a first buckling portion connected to an outer end of the first clamping portion, wherein the first buckling portion is provided with two buckling plates respectively protruding from both sides of the first clamping portion, a buckling connecting plate connected between ends of the two buckling plates, and a movable plate respectively arranged between the two buckling plates at intervals, where one end of the movable plate is connected to the buckling connecting plate, the other end is provided with a buckling point protruding outwards, and the first clamping portion is internally provided with a movable groove for the movable plate to deflect inwards; and
the second buckling member includes a second buckling body, second clamping portions connected to the second buckling body and arranged oppositely, a second buckling portion respectively extending in a direction from one second clamping portion towards an opposite second clamping portion, and a buckling limiting plate connected between ends of the two second clamping portions, where the second buckling body, the second clamping portions, and the second buckling portion surround to form a buckling groove for slidably connecting to a first buckling plate; the second buckling body is concavely provided with a point groove corresponding to the buckling point; when the first buckling member and the second buckling member are fastened and connected, the buckling point is concavely and convexly matched with the point groove; and the buckling limiting plate abuts against an end face of the first buckling portion far from the buckling point.

5. The folding cart according to claim 4, wherein the stand column assembly comprises a plurality of first support stand columns respectively connected to end portions of two adjacent shear fork groups or side column groups, two opposite sides of the door frame structure are respectively provided with a second connecting structure, the second buckling member of the two second connecting structures are respectively connected to a first support stand column correspondingly arranged at a rear side through a flexible member in a positioning manner, the second buckling portion is arranged on one side of a second buckling plate close to the object placing channel, one side of the second buckling body far away from the object placing channel and/or an outer side of the second clamping portion is convexly provided with a penetration plate arranged along a length direction of the second clamping portion, a penetration channel for the flexible member to pass through is arranged on the penetration plate, one end of the flexible member is sleeved on the penetration plate and the other end is sleeved on the first support stand columns, and the flexible member is arranged as the flexible belt, the flexible rope, or the flexible chain.

6. The folding cart according to claim 5, wherein the door frame structure comprises two door frame stand columns oppositely arranged along a longitudinal direction and a door stopping bracket connected between the two door frame stand columns, an upper end of the door frame stand column is provided with a first door frame connecting structure, and a lower end of the door frame stand column is provided with a second door frame connecting structure;
the first door frame connecting structure includes a first base fixed relative to an upper end of the door frame stand column, a first assembling portion extending in a direction from the first base towards an opposite door frame stand column, and a second assembling portion extending from the first base or the first assembling portion towards a direction close to the object placing channel, upper sides of two ends of the door stopping bracket are respectively rotatably connected to the first assembly portion of the two first door frame connecting structures, an upper end of the door stopping member is provided with a door stopping mounting buckle in buckled connection with the second assembling portion, the first buckling member is arranged on one side of the first base far away from the object placing channel, and one end of the first connecting structure is connected to one side of the first base far away from the door stopping bracket in a positioning manner; and
the second door frame connecting structure includes a second base fixed relative to a lower end of the door frame stand column, a third assembling portion extending in a direction from the second base towards an opposite door frame stand column, and a fourth assembling portion extending from the second base towards a direction far away from the first door frame connecting structure, lower sides of two ends of the door stopping bracket are respectively rotatably connected to the third assembly portion of the two second door frame connecting structures, and the fourth assembling portion is rotatably connected to a lower portion of the first support stand column.

7. The folding cart according to claim 6, wherein the front side column group, the rear side column group, and the door stopping bracket are arranged as a shear fork structure, and the stand column assembly further comprises a first assembly structure arranged at a lower portion of the first support stand column and a second assembly structure arranged on the first support stand column and above the first assembly structure;
the first assembly structure on each of the two first support stand columns at the rear side includes a first connecting base fixed relative to a lower portion of each first support stand column, a first assembly portion extending in a direction from the first connecting base towards the first underframe structure, and a second assembly portion extending in a direction from the first connecting base towards the door frame structure, both sides of a rear end of the first underframe structure are respectively rotatably connected to first assembly portions of the two first assembly structures, and the two fourth assembly portions are respectively rotatably connected to the second assembly portions of the two first assembly structures; and
the second assembly structure on each of the two first support stand columns at the rear side includes a second connecting base connected to each first support stand column, a third assembly portion extending in a direction from the second connecting base towards the rear side column group, and a fourth assembly portion extending in a direction from the second connecting base towards the left shear fork group or the right shear fork group, both sides of the rear side column group are respectively rotatably connected to the third assembly portions of the two second assembly structures, both rear ends of the left and right shear fork groups are respectively rotatably connected to the fourth assembly portion of a second assembly structure correspondingly arranged, and the other end of the first connecting structure is connected with an outer side of the second assembly structure in a positioning manner.

8. The folding cart according to claim 7, wherein the stand column assembly further comprises a second support stand column rotatably connected to the left shear fork group and a third support stand column rotatably connected to the right shear fork group; the first underframe structure comprises first underframe assemblies respectively arranged between the two first support stand columns at a front side and the lower portions of the second and third support stand columns and arranged between the two first support stand columns at a rear side and the lower portions of the second and third support stand columns; the second underframe structure comprises second underframe assemblies respectively arranged between the two first support stand columns at a front side and the lower portions of the second and third support stand columns and arranged between the two first support stand columns at a rear side and the lower portions of the second and third support stand columns; the first and second underframe assemblies are respectively provided with a first bottom rod rotatably connected to the two first support stand columns, a second bottom rod rotatably connected to the second support stand column, a third bottom rod rotatably connected to the third support stand column, and a folding connecting member; and when the cart frame body is driven to fold, the front, rear, left and right shear fork groups deform to drive each first support stand column, the second support stand column, and the third support stand column to be gathered with each other, and the first bottom rod, the second bottom rod, and the third bottom rod are gathered with each other to drive the folding connecting member to move upwards.

9. The folding cart according to claim 1, wherein the cart frame body also comprises the second underframe structure arranged above the first underframe structure, an upper side of the second underframe structure and the stand column assembly surround to form a second mounting area for mounting a second cloth cover structure, and the second mounting area is arranged above the first mounting area;
the stand column assembly includes a plurality of first support stand columns respectively connected to end portions of two adjacent shear fork groups or side column groups, first assembly structures arranged at lower portions of the first support stand columns, second assembly structures arranged at middle portions of the first support stand columns, and third assembly structures arranged at upper portions of the first support stand columns;
the second assembly structure on each of the two first support stand columns at the rear side includes a second connecting base slidably sleeved to a middle portion of each first support stand column, a third assembly portion extending in a direction from the second connecting base towards the rear side column group, a fourth assembly portion extending in a direction from the second connecting base towards the left shear fork group or the right shear fork group, and a fifth assembly portion extending in a direction from the second connecting base towards the second underframe structure; lower ends of both sides of the rear side column group are respectively rotatably connected to the third assembly portions of the two second assembly structures; lower sides of both rear ends of the left and right shear fork groups are respectively rotatably connected to the fourth assembly portion of a second assembly structure correspondingly arranged, and both sides of the rear end of the second underframe structure are respectively connected to the fifth assembly portions of the two second assembly structures;
the third assembly structure on each of the two first support stand columns at the rear side includes a third connecting base fixed relative to an upper portion of each first support stand column, a sixth assembly portion extending in a direction from the third connecting base towards the rear side column group, a seventh assembly portion extending in a direction from the third connecting base towards the left shear fork group or the right shear fork group; upper ends of both sides of the rear side column group are respectively rotatably connected to the sixth assembly portions of the two third assembly structures; and an upper side of one end of the left shear fork group and an upper side of one end of the right shear fork group are respectively rotatably connected to the seventh assembly portion of a third assembly structure correspondingly arranged; and
the first cloth cover structure is provided with a first mounting buckle arranged corresponding to each second assembly structure, a side portion of the third assembly portion or the fourth assembly portion or the fifth assembly portion is provided with a first quick-release portion detachably connected to the first mounting buckle, the second cloth cover structure is provided with a second mounting buckle arranged corresponding to each third cart frame connecting structure, and an inner side of the third connecting base is provided with a second quick-release portion detachably connected to the second mounting buckle.

10. The folding cart according to claim 3, wherein the cart frame body also comprises a second underframe structure arranged above the first underframe structure, an upper side of the second underframe structure and the stand column assembly surround to form a second mounting area for mounting a second cloth cover structure, and the second mounting area is arranged above the first mounting area;
the stand column assembly includes a plurality of first support stand columns respectively connected to end portions of two adjacent shear fork groups or side column groups, the front side column group includes a first front side column beam which is relatively fixedly connected between lower portions of the two first support stand columns at the front end and a second front side column beam which is relatively fixedly connected between middle portions of the two first support stand columns at the front end, the rear side column group includes a first rear side column beam which is relatively fixedly connected between lower portions of the two first support stand columns at the rear end and a second rear side column beam which is relatively fixedly connected between middle portions of the two first support stand columns at the rear end, the first underframe structure includes first underframe assemblies which are rotatably connected to each other and are rotatably connected to the first front side column beam and the first rear side column beam respectively, the second underframe structure includes second underframe assemblies which are rotatably connected to each other and are rotatably connected to the second front side column beam and the second rear side column beam respectively, the door frame structure includes two door frame stand columns which are oppositely arranged along a longitudinal direction and a door stopping bracket which is connected between the two door frame stand columns, and the front side column group, the rear side column group, the door stopping bracket, the first underframe assemblies and the second underframe assemblies are arranged in a plate-frame structure; and
a lower portion of the door frame structure is rotatably connected to the first rear side column beam, one end of the first connecting structure is connected to upper portions of the door frame stand column in a positioning manner and the other end is connected to the second rear side column beam in a positioning manner, the door stopping bracket includes bracket beams connected between upper ends of the two door frame stand columns, the first buckling member of the second connecting structure is formed by the bracket beams, and the second buckling member is connected to the second rear side column beam in a positioning manner.
